(19) United States
(12) Patent Application Publication
(10) Pub. No.: US 2025/0374867 A1
(43) Pub. Date: Dec. 11, 2025

(54) SYSTEMS AND METHODS FOR LOW VOLTAGE PHYSIOCHEMICAL MODIFICATION OF GRAIN

(71) Applicant: Smart Sprouts International LLC, Carpenter, WY (US)

(72) Inventor: Shawn D. Jenkins, Cheyenne, WY (US)

(73) Assignee: Smart Sprouts International LLC, Carpenter, WY (US)

(21) Appl. No.: 18/738,815

(22) Filed: Jun. 10, 2024

(51) Int. Cl. A01G 7/04; A01G 9/029

(52) U.S. Cl. CPC A01G 7/04; A01G 9/029

(57) ABSTRACT

The present disclosure relates in general to the imbibition of grains for the agronomic, horticulture, animal feed, and malting industries. More specifically, the present disclosure relates to systems and methods for improving germination and plant seedling development rates using low volts of direct current to increase the productivity, efficiency, and economics of industries that rely on grain germination and seedling development to produce a product. The application of less than or equal to approximately 36.0 volts of direct current to grains in aqueous solutions for at least approximately thirty minutes has been found to significantly improve coleoptile length, radicle length, invitro neutral detergent fiber digestibility, germination percentage, glucose concentration, and amino acid concentration on a dry matter basis.

### FIELD OF THE INVENTION

The present disclosure relates in general to the physiochemical modification of grains for the agronomic, horticulture, animal feed, and malting industries. More particularly, but not exclusively, the present disclosure relates to systems and methods for using low voltage dependent reactions—in contrast to a high voltage electric field dependent reactions—to stimulate a positive effect on seed germination and plant seeding development in grains.

### BACKGROUND

Germination is often viewed as the beginning of a plant's life. In fact, however, a dormant seed comprises a miniature plant, called an embryo, packaged along with a food supply, called endosperm, inside a protective seed coat. While the seed is dormant, growth of the embryo's root, or radicle, and the embryo's shoot, or coleoptile, remain temporarily suspended. Breaking dormancy depends on specific environmental conditions that include, but are not limited to, light, temperature, and imbibition. Imbibition is the absorption of water by a dry seed due to its lower water potential as compared to the higher water potential of the surrounding environment. Successful imbibition is required before the initiation of metabolic processes, triggering the release of phytohormones from the embryo and the onset of germination.

Phytohormones are plant hormones produced in extremely low concentrations which control all aspects of plant growth and development. One important example of a phytohormone is gibberellin, which acts as a signal for the grain to begin synthesizing and secreting digestive enzymes that hydrolyze its stored food supply, often comprising starch, proteins, and lipids. These digestive enzymes include α-amylase, an enzyme that begins to hydrolyze starch into small, soluble molecules such as oligosaccharides, fructose, maltose and glucose, which are consumed during growth of the embryo as it transitions into a seedling. While α-amylase is the most important and well-studied enzyme, other enzymes such as maltase and glucosidase are also necessary to fully hydrolyze starch to glucose for ultimate use by the plant seedling.

The rate of germination and growth of the embryo are directly influenced by two primary factors. The first factor is the embryo's ability to hydrolyze its stored food supply to produce small, soluble molecules easily consumed by the developing seedling. The second factor is the embryo's ability to quickly transfer these nutrients to the growing regions of the seedling, namely, the radicle and coleoptile. Consequently, physiochemical modifications that help break down the seed's stored food supply prior to or during imbibition, or that improve the efficiency of digestive enzymes to hydrolyze the stored food supply, are desired to enhance the rate of germination and growth of the developing seedling.

Chemical seed treatments have historically been used in the agronomic, horticulture, animal feed, and malting industries to preserve the inherent vigor of the developing seedling and to protect the seedling from pathogens or nutrient deficiencies. Indeed there are currently limited options available to preserve or enhance seedling vigor without the use of chemicals. Efforts however have intensified to reduce or eliminate chemical usage and adopt environmentally-friendly alternatives. One environmentally friendly alternative being considered is the use of electric-field dependent reactions. Largely utilized in the food processing industries, electric fields involving high voltage electric fields (“HVEFs”) and pulsed electric fields (“PEF”) have been shown to successfully physiochemically modify seeds, particularly cereal grains, to influence texture and hardness, storage capabilities, microbial contamination, and gluten properties. HVEF technology utilizes the constant application of high voltage (e.g., ≥3 kV/cm) for a set duration to treat a sample placed between two electrodes. PEF technology utilizes high voltage pulses (e.g., low/moderate-intensity, 10-2000 kV/m; high-intensity, 2000-4500 kV/m) with a duration of milliseconds to microseconds at high repetition rates (e.g., ≤3,000 pulses per second).

Translating HVEF and PEF technology from food processing to agronomic, horticulture, animal feed, and malting applications however has met varied success. For instance, the use of HVEF and PEF technology in treating seeds has, in some instances, been shown to improve imbibition, germination, and seedling growth. See, e.g., Ahmed et al., Impact of pulsed electric field treatments on the growth parameters of wheat seeds and nutritional properties of their wheat plantlets juice, FOOD SCIENCE & NUTRITION (Apr. 5, 2020) (observing that “by increasing the EF intensities and the number of pulses, the water uptake capacity [of seed] was increased” and that “PEF-treated seeds at 6 kV/cm with 50 pulses had significant leaf area (46.47%) as compared to untreated and other low-intensity-treated samples”); Krivov et al., Effect of constant high-voltage electric field on wheat seed germination, IOP SCINOTES (2020) (finding treatment with 3 kV/cm electric field does not change seed germination or affect length of radicle or coleoptile, however, “significant increase of morphological characteristics is achieved at the seed contact with the high voltage electrode” at +3 kV); Attri et al., Outcomes of Pulsed Electric Fields and Nonthermal Plasma Treatments on Seed Germination and Protein Functions, AGRONOMY, Vol. 2, Iss. 2 (Feb. 15, 2022) (finding that “low-intensity electric field has no significant effect on seed germination, seedling growth, and biochemical effect” and in contrast “the medium electric field strength is best for germination and seedling growth”); Guixue et al., Influence Of High Voltage Electrostatic Field (HVEF) On Vigour Of Aged Rice (Oryza Sativa L.) Seeds, JOURNAL OF PHYTOLOGY, Vol. 1, Iss. 6, pp. 397-403 (2009) (finding HVEF “significantly improved” seed vigour and seedling growth of aged wet rice seeds). In other instances, the use of HVEF and PEF technology in treating seeds has been shown to negatively impact imbibition, germination, and seedling growth. See, e.g., Concepcion et al., Stimulation of static electric field and exposure time on germination and stem tissues of hybrid Philippine Zea mays genotypes, 2021 IEEE 13^{TH} INTERNATIONAL CONFERENCE ON HUMANOID, NANOTECHNOLOGY, INFORMATION TECHNOLOGY, COMMUNICATION AND CONTROL, ENVIRONMENT, AND MANAGEMENT (HNICEM) (2021), (showing a reduction in germination rates, germination index, and vigor index when maize hybrids were exposed to 0.4 V/cm static electric field for ten minutes daily as compared to control); Dymek et al., Effect of pulsed electric field on the germination of barley seeds, SCIENCE DIRECT, Vol. 47, Issue 1, pp. 161-166 (June 2012) (showing a “significant reduction of radicle elongation” and a decrease in α-amylase concentration when PEF treatments were applied).

Therefore while the results of using HVEF and PEF technology to treat seeds are varied, the current research at least indicates a greater stimulation of seed germination and plant seeding development is more likely achieved at medium-to-high voltage intensities (e.g., 1-45 kV for mid-voltage, 45 to 230 kV for high voltage) as compared to low voltage (e.g., ≤1 kV). Wide scale adoption of HVEF and PEF technology to treat seeds at such mid-to-high voltage intensities however in the agronomic, horticulture, animal feed, and malting industries is limited because of the requisite high energy requirements needed for commercial production. Such high energy requirements are cost prohibitive for use on a mass scale, create significant worker safety concerns, and may mitigate any beneficial environmental impact the technology may have when accounting for the electricity needed for production and related power plant emissions. Simply put, the equipment and infrastructure needed to implement HVEF and PEF technology is currently too complex, dangerous, and capital intensive to make it a viable option for treating seeds in the agronomic, horticulture, animal feed, and malting industries.

Thus a desire remains to develop systems and methods for treating seeds that positively impact germination times and resultant seedling development across the agronomic, horticulture, animal feed, and malting industries. A desire further remains to develop systems and methods for treating seeds that are environmentally friendly, safe in the workplace, and cost efficient when applied to large scale, commercial production. A desire still further remains to develop systems and methods for treating seeds that may be uniformly applied to different types of plant species and varieties to increase the productivity, efficiency, and economics of industries that rely on grain germination and seedling development to produce a product.

### SUMMARY

In one aspect of the present disclosure, a method for treating grains is provided. The method may include forming an aqueous solution having water as a primary component. The method may further include contacting the grains with the solution, applying low volts of direct current over the grains and the solution, and maintaining the low volts of direct current for a certain period of time.

In another aspect of the present disclosure, a method for treating grains to improve germination and seedling development is provided. The method may include providing a system for imbibing grains using low volts of direct current. The method may further include introducing the grains to an aqueous solution comprising at least one metallic salt in water. The grains in solution may be placed into an electrode chamber and less than or equal to approximately 36.0 volts of direct current applied for at least approximately thirty minutes during imbibition. After imbibition, the grains may be removed from the electrode chamber and the solution and introduced into a growing station where they are developed into plant seedlings and ultimately harvested for their intended use in, e.g., the agronomic, horticulture, animal feed, and malting industries.

In another aspect of the present disclosure, a system for imbibing grains using low volts of direct current to improve germination and seedling development is provided. The system may include a plurality of grains to be imbibed, an aqueous solution for imbibing the grains containing water, an electrode chamber configured to apply low volts of direct current to the grains in the solution, and a growing station for cultivating imbibed grains into plant seedlings.

### OBJECTS, FEATURES, AND ADVANTAGES

It is a principal object, feature, and advantage of the present disclosure to overcome the aforementioned deficiencies in the art and provide systems and methods for treating seeds that positively impact germination times and resultant seedling development across the agronomic, horticulture, animal feed, and malting industries.

Another object, feature, and advantage of the present disclosure is to provide systems and methods for treating seeds that are environmentally friendly, safe in the workplace, and cost efficient when applied to large scale, commercial production.

Yet another object, feature, and advantage of the present disclosure is to provide systems and methods for treating seeds that may be uniformly applied to different types of plant species and varieties to increase the productivity, efficiency, and economics of industries that rely on grain germination and seedling development to produce a product.

A further object, feature, and advantage of the present disclosure is to provide systems and methods for treating seeds that maximize the rate at which grains imbibe water to improve germination rates, the mobilization of nutrients to the growing regions of the embryo, and the enhancement of seedling growth rates.

A still further object, feature, and advantage of the present disclosure is to provide systems and methods for treating seeds that improve the uniformity at which individual grains imbibe water and plant additives to increase yields, improve nutritional value, and reduce costs for the agronomic, horticulture, animal feed, and malting industries.

A further object, feature, and advantage of the present disclosure is to provide systems and methods for treating seeds that advance the effectiveness of insecticides and fungicides as compared to traditional surface coating procedures for agronomic applications.

A still further object, feature, and advantage of the present disclosure is to provide systems and methods for treating seeds that efficiently and effectively prime seeds for high value crops to maximize individual seed response and production in horticulture applications.

Another object, feature, and advantage of the present disclosure is to provide systems and methods for treating seeds that enable more efficient, profitable, and sustainable animal protein production in animal feeding applications, whereby enteric methane emissions from ruminants are reduced.

A further object, feature, and advantage of the present disclosure is to provide systems and methods for treating seeds that improve the rate and ratio at which input substrates are transformed into usable fermentation byproducts in malting applications, whereby wastes associated with the fermentation process such as carbon dioxide and methane are reduced.

A still further object, feature, and advantage of the present disclosure is to provide systems and methods for treating seeds that reduce greenhouse gas emissions while offering opportunities for offset or inset carbon credit generation.

Another object, feature, and advantage of the present disclosure is to provide systems and methods that are simple to use, safe to operate, and cost efficient to maintain to provide viable options for treating seeds in the agronomic, horticulture, animal feed, and malting industries.

Other objects, features, or advantages of this disclosure will become apparent from the following detailed description and claims, taken in conjunction with the accompanying drawings that set forth, by way of illustration and example and without limitation, certain aspects of this disclosure. No single aspect need provide each and every object, feature, or advantage. Thus the present disclosure is not to be limited to or by these objects, features, and advantages.

### BRIEF DESCRIPTION OF THE DRAWINGS

The accompanying drawings, incorporated herein and forming a part of the specification, illustrate aspects of the present disclosure together with the detailed description and claims.

FIG. 1 is a diagram illustrating a system of using low voltage dependent reactions to imbibe grain according to the present disclosure.

FIG. 2 is a flowchart illustrating a method of using low voltage dependent reactions to imbibe grain according to the present disclosure.

FIG. 3 is a graph showing coleoptile lengths in mm for Winner hard red winter wheat seedlings as influenced by volts of direct current (“VDC”) applied during imbibition in an aqueous solution for 120 minutes.

FIG. 4 is a graph showing radicle lengths in mm for Winner hard red winter wheat seedlings as influenced by VDC applied during imbibition in an aqueous solution for 120 minutes.

FIG. 5 is a graph showing amino acid concentration on a dry matter basis for Winner hard red winter wheat seedlings as influenced by VDC applied during imbibition in an aqueous solution for 120 minutes.

FIG. 6 is a graph showing in vitro neutral detergent fiber digestibility (“NDFD”) after thirty hours on a dry matter basis as influenced by VDC applied during imbibition in an aqueous solution for 120 minutes.

FIG. 7 is a graph showing glucose concentration on a dry matter basis for Winner hard red winter wheat seedlings as influenced by VDC applied during imbibition in an aqueous solution for 120 minutes.

FIG. 8 is a graph showing germination percentage for Winner hard red winter wheat seedlings as influenced by VDC applied during imbibition in an aqueous solution for 120 minutes.

FIG. 9 is a graph showing germination percentage for Winner hard red winter wheat seedlings as influenced by electric field (V/cm) applied during imbibition in an aqueous solution for 120 minutes.

FIG. 10 is a graph showing radicle lengths in mm for Winner hard red winter wheat seedlings for comparative samples in an aqueous solution for 120 minutes as influenced by:
a) no VDC applied during imbibition (control);
b) VDC applied during imbibition (+);
c) Seventy-five ppm magnesium sulfate (MgSO₄) in the aqueous solution applied during imbibition; and
d) Seventy-five ppm magnesium sulfate (MgSO₄) in the aqueous solution and VDC (+) applied during imbibition.

### DETAILED DESCRIPTION

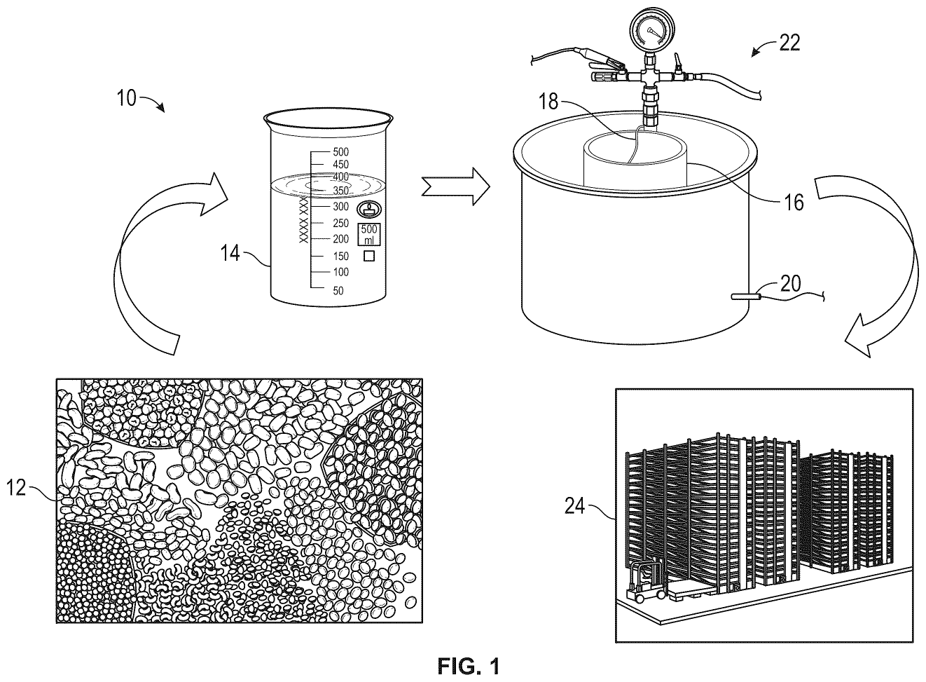

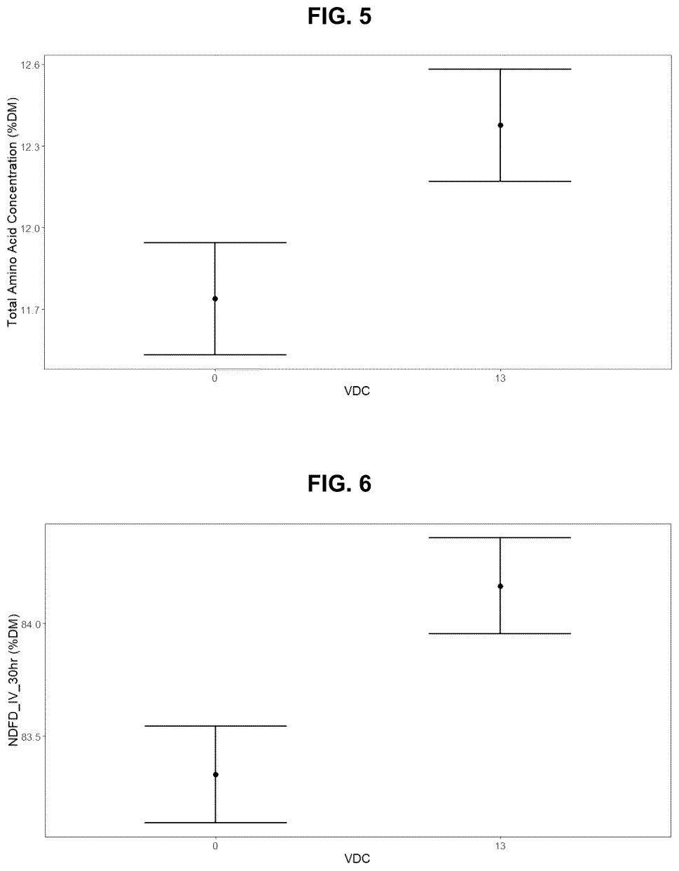

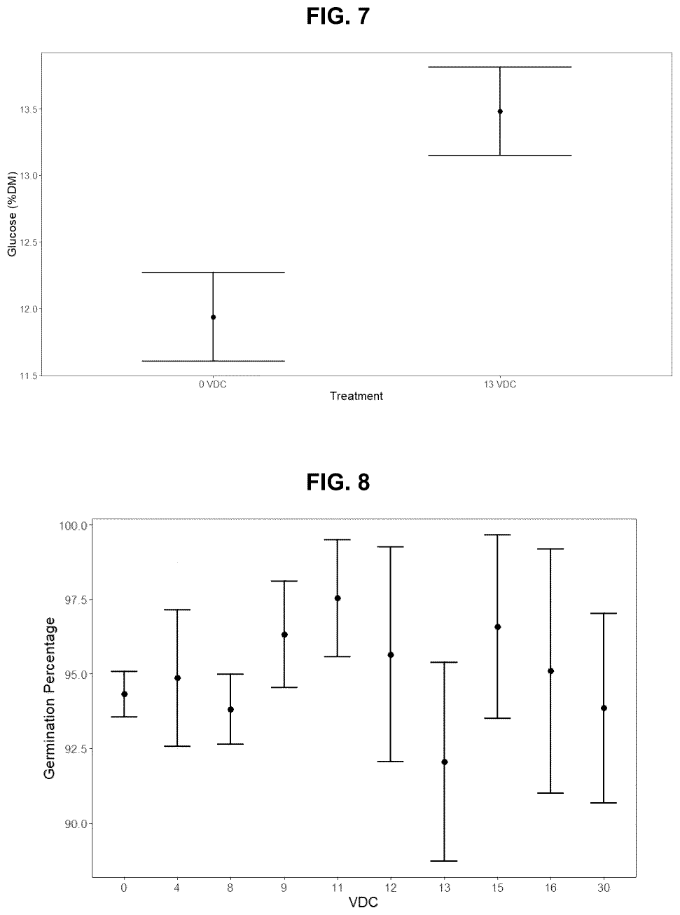

Referring generally to FIGS. 1-10, the present disclosure relates to systems and methods for treating seeds that utilize low voltage dependent reactions—in contrast to high voltage electric field dependent reactions—to stimulate a positive effect on seed germination and plant seeding development in grains. Such systems and methods may be applied across a wide variety of industries, including the agronomic, horticulture, animal feed, and malting industries. Benefits of using low voltage to treat seeds include, but are not limited to, the ability to maximize the rate at which grains imbibe water to improve germination rates, the mobilization of nutrients to the growing regions of the embryo, and the enhancement of seedling growth rates. Low voltage applications for treating seeds provide for environmentally friendly practices that are safe in the workplace and cost efficient when applied to large scale, commercial production. Moreover, additional benefits of utilizing low voltage include the ability to uniformly apply seed treatment to different types of plant species and varieties to increase the productivity, efficiency, and economics of industries that rely on grain germination and seedling development to produce a product.

Grains contemplated to be utilized with the systems and methods of the present disclosure may include any vascular seed plant, and particularly angiosperms, which possess the specialized endosperm food supply inside the seed coat. Endosperm is the chief storage tissue in the seeds of cereal grains and grain legumes, which are both utilized as major food sources by humans and animals. Cereal grains may include, but are not limited to, wheat (Triticum aestivum), corn (Zea mays), rice (Oryza sativa), wild rice (Zizania palustris), barley (Hordeum vulgare), oats (Avena sativa), rye (Secale cereale), sorghum (Sorghum bicolor), bulgur, teff Eragrostis tef), triticale (Triticosecale), and millet (Panicum millaceum). Other grains may include, but are not limited to, Amaranth, buckwheat (Fagopyrum esculentum), and quinoa (Chenopodium quinoa Willd.). Grain legumes, also known as pulses, may include, but are not limited to, soybean (Glycine max), lentil (Lens esculenta), peas (Pisum sativum), chick pea (Cicer arietinum), faba bean (Vicia faba), cowpea (Vigna sinensis), pigeonpea (Cajanas cajan, Cajanus indicus), and peanut (Arachis hypogaea).

While certain aspects of the present disclosure are shown and described herein, it is understood that such aspects are merely exemplary. The present disclosure is not intended to be limited to these specific aspects and may encompass other aspects or embodiments. Therefore, specific system and method details disclosed herein are not to be interpreted or inferred as limiting, but merely as a basis for the claims and as a representative basis for teaching one skilled in the art how to make and use the disclosed subject matter.

It must further be noted that the singular terms “a,” “an,” and “the” as used herein may include plural referents unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All words of approximation as used in the present disclosure and claims should be construed to mean “approximate,” rather than “perfect” or “exact,” and may be used as a modifier to any other word, number, quantity, quality, value, or specified parameter. Words of approximation, include, but are not limited to terms such as “about,” “approximately,” “around,” “almost,” “generally,” “largely,” “essentially,” “substantially,” etc. As used herein, in some aspects, the terms “about” or “approximately” when preceding a numerical value may indicate the value plus or minus a range of 1, 2, 3, 4, or 5 VDC. In other aspects, the terms “about” or “approximately” when preceding a numerical value may indicate the value plus or minus a range of 1, 2, 3, 4, or 5 volts per centimeter of electric field (V/cm). In further aspects, the terms “about” or “approximately” when preceding a numerical value may indicate the value plus or minus a range of 1, 2, 3, 4 or 5 inches of mercury (Hg). In still further aspects, the terms “about” or “approximately” when preceding a numerical value may indicate the value plus or minus a range of 1, 2, 3, 4, or 5 mm. In some aspects, the terms “about” or “approximately” when preceding a numerical value may indicate the value plus or minus a range of 1, 2, 3, 4, or 5 ppm. In other aspects, the terms “about” or “approximately” when preceding a numerical value indicates the value plus or minus a range of 1, 2, 3, 4, or 5 ml. In further aspects, the terms “about” or “approximately” when preceding a numerical value indicates the value plus or minus a range of 1, 2, 3, 4, or 5 seconds. In still further aspects, the terms “about” or “approximately” when preceding a numerical value indicates the value plus or minus a range of 1, 2, 3, 4, or 5 minutes.

Furthermore the transitional phrase “comprising” that is synonymous with “including,” “containing,” and “characterized by” as used herein is inclusive or open-ended and does not exclude additional, unrecited elements, steps or ingredients. Alternatively the transitional phrase “consisting of” as used herein is closed and excludes any element, step or ingredient not specified. The transitional phrase “consisting essentially of” limits the scope of a claim to the specified materials or steps and those that do not materially affect the basic and novel characteristics of the claims.

For purposes of the present disclosure, the terms “low voltage,” “low volts of direct current,” “low voltage direct current,” and “low VDC” are used interchangeably and defined herein as “approximately less than or equal to 36.0 volts direct current.” The terms “high voltage,” “high volts of direct current,” “high voltage direct current,” and “high VDC” are used interchangeably and defined herein as “approximately greater than or equal to 1.0 kilovolts direct current.” The terms “high voltage electric field” and “HVEF” are used interchangeably and defined herein as “approximately greater than or equal to 3.0 kilovolt/cm.” The terms “negative pressure,” “reduced pressure,” and “vacuum pressure” are used interchangeably and defined herein as “pressure that is less than standard atmospheric pressure.” The term “standard atmospheric pressure” is defined herein as “29.92 inches of mercury (Hg).”

FIG. 1 illustrates one aspect of the present disclosure, in particular, a system (10) for imbibing grains (12) using low voltage to stimulate a positive effect on seed germination and plant seeding development. The system (10) may comprise a plurality of grains (12) to be imbibed, including at least one of cereal grains, grain legumes, and other grains for animal or human consumption. The grains (12) may be intended for use in commercial applications such as, but not limited to, the following industries:
Seed priming applications to improve germination and seedling development traits for the agronomic industries;
Seed priming applications to high value crops to maximize individual seed response and yield production for the horticulture industries;
Seed priming applications to maximize germination uniformity, enzyme yield, and fermentable sugar yield for the malting industries, whereby wastes associated with the fermentation process such as carbon dioxide and methane are reduced.
Seed priming applications to maximize germination rates, enzyme yield, and fermentable sugar yield in grain to provide a more efficient, profitable, and sustainable animal protein production for the animal feeding industries, whereby enteric methane emissions and carbon dioxide emissions from ruminants are reduced.
Seed priming applications to influence texture and hardness, storage capabilities, microbial contamination, and gluten properties of cereal grains for the human nutrition and food industries.

Shown in FIG. 1, the system (10) may further comprise an aqueous solution (14) for imbibing the grains (12). As a non-limiting example, the solution (14) may comprise approximately 2000 ml of sterilized distilled water (H₂O). In some instances, the solution (14) may optionally comprise at least approximately seventy-five ppm of metallic salts. Metallic salts contemplated by the present disclosure include, but are not limited to, magnesium sulfate (MgSO₄), potassium nitrate (KNO₃), sodium chloride (NaCl), or combinations thereof. In some aspects, the metallic salts may comprise magnesium sulfate (MgSO₄) at approximately 75-85 ppm, potassium nitrate (KNO₃) at approximately 140-160 ppm, sodium chloride (NaCl) at approximately 75-85 ppm, or combinations thereof. In other aspects, the metallic salts may comprise magnesium sulfate (MgSO₄) at approximately 75 ppm and potassium nitrate (KNO₃) at approximately 150 ppm. In further aspects, the metallic salts may comprise magnesium sulfate (MgSO₄) at approximately 75 ppm. In still further aspects, the metallic salts may comprise potassium nitrate (KNO₃) at approximately 150 ppm. In other aspects, the metallic salts may comprise sodium chloride (NaCl) at approximately 75 ppm. While optional, the introduction of metallic salts into the solution (14) may increase the effectiveness of the low voltage treatment in stimulating a positive effect on seed germination and plant seeding development. Metallic salts, when dissolved in water, dissociate into charged ions that become mobile and can conduct electricity. The presence of mobile ions in the water increases the overall conductivity of the water and allows the electric current to flow more easily through the solution (14) and through the grains (12). In addition to increased conductivity, the uniformity of the electric field is improved with increased conductivity thereby increasing the effective range of the electric application. Uniformity of the low voltage electric field is one of the biggest obstacles when applying low voltage direct current to an aqueous solution, and the inclusion of metallic salts appear to help overcome this obstacle.

In some aspects, the solution (14) may optionally comprise approximately 3.0-10.0 ppm of plant additives in the approximately 2000 ml of sterilized distilled water (H₂O). Plant additives contemplated to be imbibed into grains using the systems and methods of the present disclosure include, but are not limited to, nutrients, fungicides, insecticides, signaling compounds, and exogenous phytohormones. Exemplary exogenous phytohormones of the present disclosure include, but are not limited to, cytokinins for promoting cell division (e.g., synthetic cytokinin thidiazuron), auxins for promoting plant growth (e.g., synthetic auxin 1-Naphthaleneacetamide), and gibberellins for controlling seed germination (e.g., gibberellic acid (GA₃)). As a non-limiting example, the solution (14) may optionally comprise approximately 3.0-10.0 ppm of GA₃. In other examples, the solution (14) may optionally comprise approximately 0.75-10.0 ppm of GA₃, approximately 1.0 ppm of 1-Naphthaleneacetamide, and approximately 1.0-5.0 ppm of thidiazuron.

In other aspects, the solution (14) may optionally include approximately 40.0-60.0 ppm of a reactive oxygen species (ROS). ROS are a class of highly reactive and oxygen-bearing molecules that include superoxide anion (O₂·⁻), hydrogen peroxide (H₂O₂), hydroxyl radical (OH), and singlet oxygen (¹O₂). It is well known that ROS plays an important role in the regulation of seed dormancy, germination, and deterioration. See Kurek et al., Reactive Oxygen Species as Potential Drivers of the Seed Aging Process, PLANTS, Vol. 8, Iss. 6, p. 174 (Jun. 14, 2019); see also Considine et al., Oxygen and reactive oxygen species-dependent regulation of plant growth and development, PLANT PHYSIOLOGY, Vol. 186, Iss. 1, pp. 79-92 (May 27, 2021). In particular, ROS may interact with the hard outer layer of the seed coat causing it to weaken and permit water to enter quickly to initiate germination. It is also well known that ROS may be used as a weapon against pathogens on the seed coat, being either directly toxic against pathogenic microorganisms or trigger hypersensitive reaction and programmed cell death at sites attacked by pathogens. See Lamb et al., The Oxidative Burst In Plant Disease Resistance, ANNUAL REVIEW OF PLANT BIOLOGY, Vol. 48, pp. 251-274 (June 1997). Therefore, utilizing ROS in the solution (14) will likely constitute a defense reaction for the grains (12) against infection by harmful microorganisms.

Further shown in FIG. 1, the system (10) may comprise an electrode chamber (16) for applying low voltage to the grains (12) in the solution (14) for a set imbibition duration time. The electrode chamber (16) may include a 5.7 L container formed from high quality, durable insulating materials such as polyethylene or polypropylene for holding the grains (12) in the solution (14). The electrode chamber (16) may further comprise at least one positively charged electrode (18), or anode, and at least one negatively charged electrode (20), or cathode. The positively charged electrode (18) may be introduced into the solution (14) and connected to an external power supply (not shown) designed to apply low voltage to the system (10). The negatively charged electrode (20) may be connected to a grounding source, such as but not limited to, the container of the electrode chamber (16) holding the grains (12) in solution (14) and/or a vessel of a vacuum chamber (22), when utilized. Direction of polarity in the system (10) is important to achieve maximum positive effects on seed germination and plant seedling development. In particular, the positively charged electrode (18) should be introduced into the solution (14) and the negatively charged electrode (20) connected to the container of the electrode chamber (16). If the direction of polarity is reversed, limited positive effects to seed germination and plant seedling development are achieved. It is also contemplated by the present disclosure that alternative electrode chambers (16) and power supplies of different sizes and strengths may also be utilized in the system (10) depending on the amount of grains (12) needed to be imbibed, such as for large scale industrial applications.

Still further shown in FIG. 1, in some instances, the system (10) may optionally include a vacuum chamber (22). The electrode chamber (16) may be positioned inside the vacuum chamber (22) from which air and other gases are removed by a vacuum pump. The vacuum chamber (22) is configured to create a low-pressure environment inside its chamber, commonly referred to as a vacuum. The vacuum chamber (22) may be comprised of stainless steel, aluminum, other metals, or rigid plastics. As a non-limiting example, the vacuum chamber (22) may include a 19 L enclosure connected to a 3.6 cubic feet/minute (CFM) single-stage vacuum pump. Alternative vacuum chambers (22) of different sizes and strengths may also be utilized in the system (10).

Also shown in FIG. 1, the system (10) may comprise a growing station (24) for cultivating the imbibed grains into plant seedlings. In some aspects, the growing station (24) may comprise soil cultivation such as in large scale outdoor agricultural production operations that involve extensive land, machinery, and labor resources to produce crops or raise livestock. In other aspects, the growing station (24) may comprise indoor and/or outdoor stations where grains are grown hydroponically or aeroponically using natural light, artificial light, or combinations thereof. While both hydroponics and aeroponics cultivate plants without soil, the techniques are distinct. In hydroponics plants are typically submerged in water that has been enriched with nutrients. Conversely in aeroponics, the roots of plants are suspended in the air and misted with water that has been enriched with nutrients. When compared to soil-cultivated plants, hydroponic and aeroponic growing stations provide improved growth, yield, quality, and production to the plant seedling. Aeroponics provide even greater benefits when compared to hydroponics, where plants grown aeroponically have 100% access to CO₂ for photosynthesis and consume 70% less water than hydroponics. (Kumar et al., 2023). Thus, in preferred aspects of the present disclosure the growing station (24) comprises aeroponics.

As a non-limiting example, the growing station (24) of the present disclosure may comprise a vertical series of platforms forming a tower structure. Each platform of the series may comprise a plurality of seed trays for housing the grains (12), wherein each seed tray may be approximately 8-12 feet in width and 10-14 feet in length. Each seed tray may be configured to house grains (12) placed therein at approximately 1-3 inches in thickness. Each platform of the tower may comprise a series of misting nozzles located above the seed trays, the misting nozzles designed to mist the grains (12) at set intervals with water that has been enriched with nutrients for optimal germination, uniformity, and growth of the plant seedlings. The growing station (24) may be a closed loop system that includes at least one storage tank used to store nutrient-rich water for application to the grains, in addition to conserving excess water after grain application, wherein the excess water may be later reapplied to the grains to reduce water consumption and improve efficiency of the growing station (24). The growing station (24) may be housed indoors or outdoors and use natural light, artificial light, or combinations thereof to initiate germination and encourage rapid growth of the plant seedlings for improved yields and performance. Once the plant seedling reaches a preferred stage of growth, the seed trays housing the grains may be removed from their respective platforms on the tower structure and the plant seedlings harvested for their intended use in the agronomic, horticulture, animal feed, and malting industries.

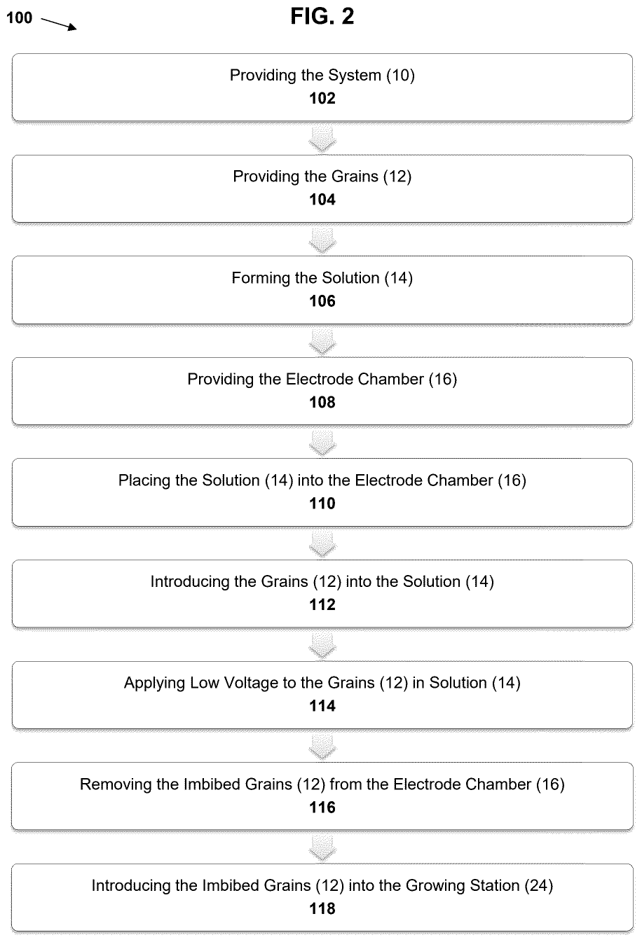

FIG. 2 illustrates another aspect of the present disclosure, in particular, a method (100) for imbibing grains (12) using low voltage to stimulate a positive effect on seed germination and plant seeding development. The method (100) may comprise providing (102) the system (10) of FIG. 1, along with the grains (12) for imbibition (104). The method (100) may further comprise forming (106) the solution (14). The solution (14) may be formed by providing approximately 2000 ml of sterilized distilled water (H₂O) chilled to approximately 6°-18° Celsius.

In some instances, the method (100) may optionally comprise introducing at least approximately seventy-five ppm of metallic salts into the sterilized distilled water (H₂O) to form the solution (14). Metallic salts contemplated by the present disclosure include, but are not limited to, magnesium sulfate (MgSO₄), potassium nitrate (KNO₃), sodium chloride (NaCl), or combinations thereof. In some aspects, the metallic salts may comprise magnesium sulfate (MgSO₄) at approximately 75-85 ppm, potassium nitrate (KNO₃) at approximately 140-160 ppm, sodium chloride (NaCl) at approximately 75-85 ppm, or combinations thereof. In other aspects, the metallic salts may comprise magnesium sulfate (MgSO₄) at approximately 75 ppm and potassium nitrate (KNO₃) at approximately 150 ppm. In further aspects, the metallic salts may comprise magnesium sulfate (MgSO₄) at approximately 75 ppm. In still further aspects, the metallic salts may comprise potassium nitrate (KNO₃) at approximately 150 ppm. In other aspects, the metallic salts may comprise sodium chloride (NaCl) at approximately 75 ppm. In other instances, the method (100) may optionally comprise introducing approximately 3.0-10.0 ppm of plant additives into the sterilized distilled water (H₂O) to form the solution (14). As a non-limiting example, the plant additives may comprise at least one of the exogenous phytohormones cytokinin thidiazuron, auxin 1-Naphthaleneacetamide, and gibberellic acid (GA₃). In some aspects, the solution (14) may comprise approximately 3.0-10.0 ppm of GA₃. In other aspects, the solution (14) may comprise approximately 0.75-10.0 ppm of GA₃, approximately 1.0 ppm of 1-Naphthaleneacetamide, and approximately 1.0-5.0 ppm of thidiazuron.

In further instances, the method (100) may optionally comprise introducing approximately 40.0-60.0 ppm of an ROS into the sterilized distilled water (H₂O) to form the solution (14). As a non-limiting example, the ROS may comprise hydrogen peroxide (H₂O₂).

It is contemplated by the present disclosure that the optional metallic salts, the optional plant additives, the optional ROS, or combinations thereof, may be mixed in the sterilized distilled water (H₂O) to form the solution (14). It is further contemplated by the present disclosure that the mixture of optional metallic salts, optional plant additives, optional ROS, or combinations thereof, in the sterilized distilled water (H₂O) may comprise a homogeneous mixture or a heterogeneous mixture to form the solution (14).

Shown in FIG. 2, the method (100) may comprise providing (110) the electrode chamber (16). The method (100) may further comprise placing (112) the solution (14) into the container of the electrode chamber (16), and thereafter introducing (114) the grains (12) into the solution (14). In particular, the positively charged electrode (18) of the electrode chamber (16) should be introduced into the solution (14) and the negatively charged electrode (20) connected to the container of the electrode chamber (16). As explained above, direction of polarity in the system (10) is important to achieve maximum positive effects on seed germination and plant seedling development, as reverse polarity fails to achieve similar results. See supra, p. 18. Using the electrode chamber (16), low voltage may be applied to the grains (12) in the solution (14) at a certain VDC and for a set imbibition duration time to stimulate the positive effect on seed germination and plant seeding development. As a non-limiting example, a maximum voltage of approximately 36.0 VDC constantly applied to the grains (12) in the solution (14) for a minimum imbibition duration time of approximately thirty minutes is needed to realize positive effects in seed germination and plant seedling development. In some aspects, low voltage may be constantly applied to the grains (12) in the solution (14) at approximately 8.0-13.0 VDC for a minimum imbibition duration time of approximately 120 minutes. In other aspects, low voltage may be constantly applied to the grains (12) in the solution (14) at approximately 5.0-7.0 VDC for a minimum imbibition duration time of approximately 120 minutes. In further aspects, low voltage may be constantly applied to the grains (12) in the solution (14) at approximately 2.0-4.0 VDC for a minimum imbibition duration time of approximately 120 minutes.

The method (100) may optionally comprise providing (110) the vacuum chamber (22). The method (100) may comprise placing the electrode chamber (16) into the vacuum chamber (22), and applying negative or reduced pressure to the grains (12) in the solution (14) at a certain pressure and for a set imbibition duration time to promote rapid and uniform rates of imbibition. As a non-limiting example, negative pressure may be applied to the grains (12) in the solution (14) at approximately 10.0-25.0 inches of mercury (Hg) for approximately 60-240 minutes. In some aspects, negative pressure may be constantly applied to the grains (12) in the solution (14) at approximately 10.0 inches of mercury (Hg) for a total imbibition duration time of approximately 180 minutes. In other aspects, negative pressure may be constantly applied to the grains (12) in the solution (14) at approximately 20.0 inches of mercury (Hg) for approximately 180 minutes. In other aspects, negative pressure may be constantly applied to the grains (12) in the solution (14) at approximately 25.0 inches of mercury (Hg) for approximately 180 minutes. In further aspects, negative pressure may be intermittently applied to the grains (12) in the solution (14) at approximately 10.0 inches of mercury (Hg) for a total imbibition duration time of approximately 180 minutes, wherein the negative pressure may be released for approximately twenty seconds at fifteen minute intervals during the total imbibition duration time. A minimum negative pressure of approximately 10.0 inches of mercury (Hg) applied to the grains (12) in the solution (14) for a minimum imbibition duration time of approximately sixty minutes is needed to realize positive effects in rapid and uniform rates of imbibition.

The method (100) may also optionally comprise applying vibration to the vacuum chamber (22) during imbibition of the grain (12) for a set time period and at a chosen vibrational frequency. As a non-limiting example, vibration may be applied to the vacuum chamber (22) during imbibition of the grain (12) for approximately one minute every fifteen minutes of the imbibition duration time. Alternatively, vibration may be constantly applied to the vacuum chamber (22) during the total imbibition duration time. As a further non-limiting example, vibration may be applied to the vacuum chamber (22) during imbibition of the grain (12) at a vibration frequency of approximately thirty-three Hertz (Hz), or about 2,000 revolutions per minute (RPM). Vibration of the vacuum chamber (22) may influence a seed coat's inherent surface tension and slightly hydrophobic nature to promote imbibition. Thus vibration of the vacuum chamber (22) may help to mitigate variations in water and plant additive imbibition rates that may negatively impact germination times and resultant seedling development.

Still further shown in FIG. 2, after low voltage has been applied (114) to the grains (12) in solution (14) for the set imbibition duration time (including the optional negative pressure and/or optional vibration applications), the grains (12) may be removed (116) from the electrode chamber (16) and introduced (118) into the growing station (24). Once the grains germinate and reach a preferred stage of growth in plant seedling development, the plant seedlings may be removed from the growing station (24) and harvested for their intended use in the agronomic, horticulture, animal feed, or malting industries.

### EXAMPLES

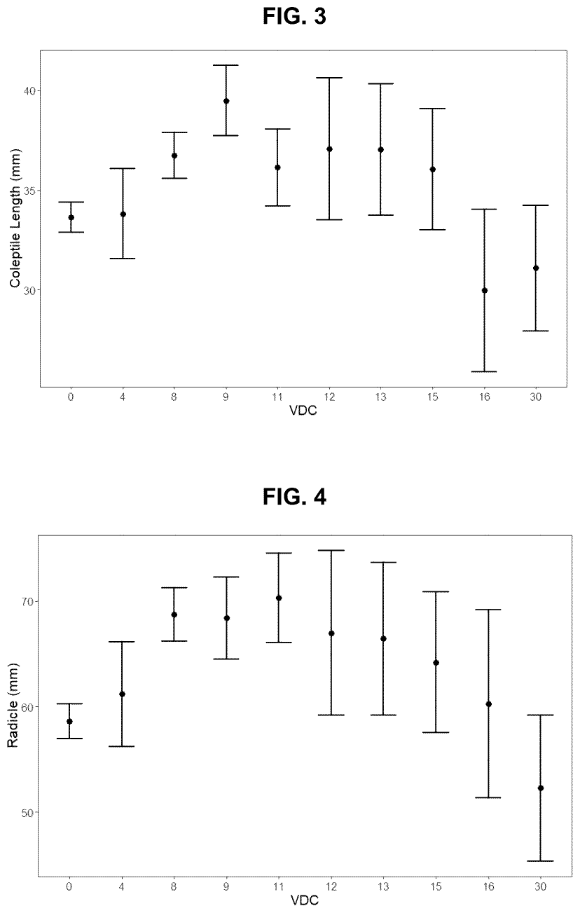

Illustrated in FIGS. 3-10, the following non-limiting examples demonstrate the benefits of low voltage dependent reactions—in contrast to high voltage electric field dependent reactions—to stimulate a positive effect on seed germination and plant seeding development in grains. In each example, approximately 1,000 g samples of Winner hard red winter wheat (Triticum aestivum) were submerged in approximately 2,000 ml of water, chilled to about 12° C., and low VDC was applied for approximately 180 minutes during imbibition. Low VDC was applied utilizing a 5.7 L electrode chamber where the positively charged electrode was introduced to the solution with the grains and the negatively charged electrode was connected to the container of the electrode chamber. Where indicated in the examples, vacuum was applied utilizing a 5.7 L vacuum chamber connected to a 3.6 CFM single-stage vacuum pump, and magnesium sulfate (MgSO₄) and/or potassium nitrate (KNO₃) introduced at rates shown.

Germination percentages were evaluated according to Association of Official Seed Analysts (“AOSA”) Standards. Germination testing was performed with one hundred seed replicates on germination testing paper. Uniform temperature at approximately 22° Celsius and lighting at around 1,000 lux was provided during the germination testing period, with grains evaluated at ninety-six hours for radicle and coleoptile emergence. Germination percentages were calculated by subtracting the total number of non-viable or abnormal seedlings from one hundred. Coleoptile and radicle lengths were measured and reported to the nearest millimeter.

Seedling composition was assessed through near infrared spectroscopy, and expressed as concentration on a dry weight basis, with enzymatic activity being indirectly assessed through glucose, amino acid, and invitro neutral detergent fiber digestibility on a dry weight basis. To estimate dry weight basis, samples were dried at approximately 50° C. for around thirty hours, weighed, and reported to the nearest 0.1 grams.

### Example 1: Effects of Application of Low VDC During Imbibition

Demonstrated in FIGS. 3-8, presented as least square mean estimates and 95% confidence intervals, it may be observed that the application of low VDC to the sample grains, significantly (p<0.05) improved coleoptile length, radicle length, invitro neutral detergent fiber digestibility, germination percentage, glucose and amino acid concentration and yield on a dry matter basis. This is surprising and unexpected as previous studies indicated that only high voltage electric fields and high VDC treatments could be used to successfully physiochemically modify seeds, as compared to low voltage treatments that were ineffective. See, e.g., Ahmed et al., Impact of pulsed electric field treatments on the growth parameters of wheat seeds and nutritional properties of their wheat plantlets juice, Food Science & Nutrition (Apr. 5, 2020) (observing that “PEF-treated seeds at 6 kV/cm with 50 pulses had significant leaf area (46.47%) as compared to untreated and other low-intensity-treated samples”); Krivov et al., Effect of constant high-voltage electric field on wheat seed germination, IOP SciNotes (2020) (finding treatment with 3 kV/cm electric field does not change seed germination or affect length of radicle or coleoptile); Attri et al., Outcomes of Pulsed Electric Fields and Nonthermal Plasma Treatments on Seed Germination and Protein Functions, Agronomy, Vol. 2, Iss. 2 (Feb. 15, 2022) (finding that “low-intensity electric field has no significant effect on seed germination, seedling growth, and biochemical effect”). For these reasons, the stimulatory effects found by the present disclosure on both coleoptile and radicle lengths using low VDC during imbibition were unexpected. Moreover, the stimulatory effects found by the present disclosure on glucose concentration, fiber digestibility, and total amino acid concentration using low VDC during imbibition were also unexpected. The results in Example 1 thus demonstrate that the application of low voltage during imbibition assists in grain hydration to improve germination percentages, in addition to other stimulatory effects comprising nutrient composition and seedling development.

### Example 2: Effects of Application of Low Electric Field (V/Cm) During Imbibition

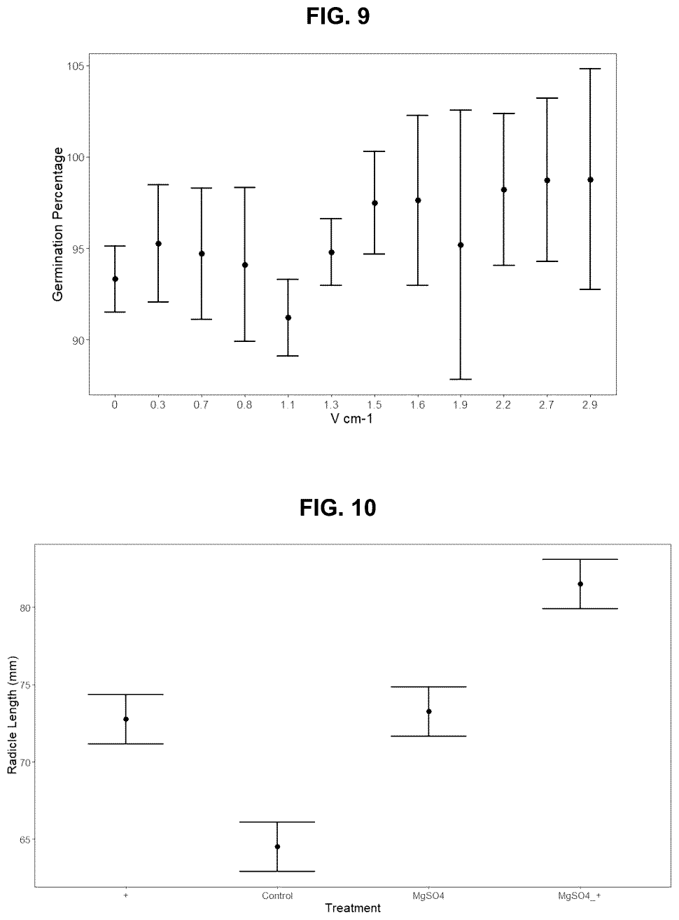

Demonstrated in FIG. 9, presented as least square mean estimates and 95% confidence intervals, it may be observed that the application of low electric field (V/cm) to the sample grains, did not significantly (p<0.05) improve germination percentage. The test results shown in FIG. 9 indicate that physiochemical modifications to grains are associated with voltage dependent reactions, as opposed to electric field dependent reactions. See, e.g., FIG. 8 compared to FIG. 9. This is surprising and unexpected as previous studies indicated physiochemical reactions in grains are electric field dependent. See, e.g., Rifna et al., Emerging technology applications for improving seed germination, TRENDS IN FOOD SCIENCE & TECHNOLOGY, Vol. 86, pp. 95-108 (April 2019) (disclosing that when an electric field is employed for a few microseconds under PEF treatment the basic cell structure is changed wherein the membrane of the cell is broken down in a process known as electroporation); Ries et al., Germination of bean seeds (Vigna unguiculata L. Walp.) in strong electric fields, METHODSX, Vol. 11 (December 2023) (reporting that applied field strength of 945 V/cm “strongly increased” seedling vigor during early growth stages). The results in Example 2 thus directly contradict such previously held understandings about grains and demonstrate physiochemical reactions are voltage dependent. Because physiochemical reactions are voltage dependent a lower VDC may thus be utilized to successfully treat grains as compared to HVEF and PEF technology.

### Example 3: Effects of Application of Low VDC and Metallic Salts During Imbibition

Demonstrated in FIG. 10, which shows the least square mean estimates and 95% confidence intervals of the data presented, it may be observed that the combination of metallic salts (e.g., seventy-five ppm magnesium sulfate (MgSO₄)) and the application of low VDC to the sample grains (e.g., approximately 13.0 VDC), significantly (p<0.05) improved radicle length as compared to a control, and as compared to applying low VDC or metallic salts alone. This is surprising and unexpected as there do not appear to be previous studies examining the interaction of metallic salts with the application of low VDC. Therefore because the use of metallic salts in the present disclosure increased the stimulatory effect on grain imbibition, germination, and seedling development, this again demonstrates such physiochemical reactions are voltage dependent.

The present disclosure is not to be limited to the particular aspects and examples described herein. In particular, the disclosure contemplates numerous variations in systems and methods for using low voltage dependent reactions—in contrast to a high voltage electric field dependent reactions—to stimulate a positive effect on seed germination and plant seeding development in grains. The systems and methods for treating seeds of the present disclosure may be uniformly applied to diverse types of plant species and varieties to increase the productivity, efficiency, and economics of industries that rely on grain germination and seedling development to produce a product. The foregoing description has been presented for purposes of illustration and description. It is not intended to be an exhaustive list or limit any of the disclosure to the precise forms disclosed. It is contemplated that other alternatives or exemplary aspects are considered included in the invention. The description is merely examples of aspects, processes, or methods of the disclosure. It is understood that any other modifications, substitutions, and/or additions can be made, which are within the intended spirit and scope of the disclosure.

What is claimed is:

1: A method for treating grains, comprising:
forming a solution comprising water;
contacting the grains with the solution;
applying low volts of direct current to the grains and the solution for a first selected value; and
maintaining the low volts of direct current for a first chosen time period.

2: The method of claim 1, wherein the grains are chosen from barley, wheat, corn, sorghum, rice, oats, rye, and triticale, and mixtures thereof.

3: The method of claim 2, wherein the grains comprise Winner hard red winter wheat seedlings.

4: The method of claim 1, wherein the first selected value of low volts of direct current is less than or equal to approximately 36.0 volts of direct current, and the first chosen time period is at least approximately thirty minutes.

5: The method of claim 1, wherein the first selected value of low volts of direct current is approximately 8.0-13.0 volts of direct current, and the first chosen time period is at least approximately 120 minutes.

6: The method of claim 1, wherein the solution further comprises at least one metallic salt.

7: The method of claim 6, wherein the at least one metallic salt comprises magnesium sulfate (MgSO₄), potassium nitrate (KNO₃), or combinations thereof.

8: The method of claim 7, wherein the at least one metallic salt comprises at least approximately 75 ppm of solution.

9: The method of claim 1, further comprising the step of:
reducing the pressure over the grains and the solution to a second selected value during the first chosen time period.

10: The method of claim 9, wherein the second selected value of reduced pressure is approximately 10.0-25.0 in. of Hg.

11: The method of claim 10, further comprising the step of vibrating the grains and the solution at a chosen vibrational frequency and for a second chosen time period during said step of reducing the pressure.

12: A method for treating grains to improve germination and seedling development, comprising:
providing a system for imbibing grains using low volts of direct current, the system comprising
a) a plurality of grains to be imbibed;
b) an aqueous solution for imbibing the grains, the solution comprising:
i. water;
ii. a minimum of 75 ppm of at least one metallic salt;
c) an electrode chamber;
d) a growing station for cultivating imbibed grains into plant seedlings;
placing the solution into the electrode chamber;
introducing the grains into the solution;
introducing a positively charged electrode of the electrode chamber into the solution with the grains;
connecting a negatively charged electrode of the electrode chamber to a grounding source;
applying low volts of direct current over the grains and the solution to a first selected value comprising less than or equal to approximately 36.0 volts of direct current;
maintaining the low volts of direct current for a first chosen time period comprising at least approximately thirty minutes;
removing imbibed grains from the electrode chamber and the solution;
introducing the imbibed grains into the growing station;
growing the grains in the growing station into plant seedlings; and
harvesting the plant seedlings.

13: The method of claim 12, wherein the grains are chosen from barley, wheat, corn, sorghum, rice, oats, rye, and triticale, and mixtures thereof.

14: The method of claim 12, wherein the first selected value of low volts of direct current is approximately 8.0-13.0 volts of direct current, and the first chosen time period is at least approximately 120 minutes.

15: The method of claim 12, wherein the at least one metallic salt comprises magnesium sulfate (MgSO₄), potassium nitrate (KNO₃), or combinations thereof.

16: The method of claim 12, further comprising stimulating a positive effect on seed germination and plant seeding development in grains using low voltage dependent reactions in contrast to high voltage electric field dependent reactions.

17: The method of claim 12, wherein the system further comprises a vacuum chamber configured to apply negative pressure to the grains in the solution.

18: The method of claim 17, further comprising the steps of:
applying negative pressure over the grains and the solution to a first selected value comprising approximately 10.0-25.0 in. of Hg;
maintaining the negative pressure for the first chosen time period.

19: The method of claim 18, further comprising the step of:
vibrating the vacuum chamber at a chosen vibrational frequency during said step of maintaining the negative pressure for the first chosen time period.

20: A system for imbibing grains to improve germination and seedling development, the system comprising:
a plurality of grains to be imbibed;
an aqueous solution for imbibing the grains, the solution comprising:
i. water;
ii. a minimum of 75 ppm of at least one metallic salt;
an electrode chamber configured to apply low volts of direct current to the grains in the solution; and
a growing station for cultivating imbibed grains into plant seedlings.
